(19) United States
(12) Patent Application Publication
(10) Pub. No.: US 2019/0338869 A1
(43) Pub. Date: Nov. 7, 2019

(54) TUBE WITH INDICATION FUNCTION

(71) Applicant: Toford Plastic Mfg., Corp., Pingtung County (TW)

(72) Inventor: Fu-Chia Cheng, Pingtung County (TW)

(21) Appl. No.: 15/970,886

(22) Filed: May 4, 2018

(51) Int. Cl. F16L 11/12; G02B 17/00; B32B 27/12; B32B 1/08; B32B 27/20

(52) U.S. Cl. CPC F16L 11/124; G02B 17/002; H02G 3/0481; B32B 1/08; B32B 27/20; B32B 27/12

(57) ABSTRACT

A tube with indication function is provided, including a reflection layer and an organization layer. The reflection layer is located on the outermost layer of the tube. The reflection layer is transparent and includes a number of reflectors that are capable of reflecting light densely distributed therein. With the tube being set up in a dark environment and irradiated with light, the light may transmit through the transparent reflection layer to reach the reflectors distributed in the reflection layer such that the reflectors reflect the light back to project the light outward. The reflection of light makes the tube noticeable to achieve an effect of indication, allowing a user to visually identify the location of the tube.

### (a) TECHNICAL FIELD OF THE INVENTION

The present invention relates generally to a tube with indication function, and more particularly to a tube with indication function that can quickly show up through reflection of light upon being irradiated with light in a dark environment so as to allow people to easily identify where the tube is currently located.

### (b) DESCRIPTION OF THE PRIOR ART

Conveyance of liquid or gas is often made with tubes and pipes. Tubes that are used for such a purpose of conveyance are generally of two types, one being rigid tubes, the other being flexible ones. Rigid tubes are often used in permanent and fixed construction jobs, while flexible tubes are used for temporary operations and jobs.

The flexible tubes are generally resilient and curvable, making it possible to fit to different terrain configurations. Due to such characteristics, the flexible tubes are often involved in applications in special environments, such as electric cable conduits and oxygen supply conduits in mines or underground tunnels, where lighting is generally poor or even not available and lighting must be provided for illumination purposes to allow for vision in such an environment. One possible way of lighting in such an environment is a handheld torch or a head torch (or head light). However, in such a dark environment, even a torch or a head light is used for lighting, such lighting is generally poor or insufficient, making the environment dim and human vision would be poor. In case of emergency, due to being set in tension, people who are nervous would exhibit poor capability in finding out or recognizing small tubes of cable conduits or oxygen supply conduits in such a dim or dark environment. This means the potential risk for such people is escalating with the lapse of time spent in looking for such conduits. This is threatening to people staying in such an environment and facing such a trouble. A known way to handle such an issue is to attach light-reflecting stickers to the tubes or conduits. However, this would require additional expense for attaching the stickers to the tubes. In addition, the stickers, which are exposed outside the tubes or conduits, may get detached from the tube due to deterioration of adhesive of the stickers after a long lapse of time or due to being removed inadvertently. In addition, residues of the adhesive of the stickers may be left on the outside surfaces of the tubes once the stickers are removed. Additional costs are necessary for handling such residue of adhesive. These are just some factors that cause inconvenience of using the light-reflecting stickers for such a purpose.

Thus, it is the challenge for all related fields to provide a solution that allows a tube to be easily visible and recognizable in a dark or dim environment in order to reduce the potential risk that a person in such an environment may encounter, while at the same time eliminates all the drawbacks associated with the light-reflecting stickers discussed above.

### SUMMARY OF THE INVENTION

The present invention relates to a tube with indication function, of which the main purpose is to overcome the drawback that a conventional tube that is located in a dark environment may be hard to see or recognize even being illuminated up with external light.

To achieve the above objective, the present invention provides a tube with indication function. The tube with indication function according to the present invention comprises a reflection layer and an organization layer, wherein the reflection layer is located on an outermost layer of the tube and the reflection layer is transparent and thus light transmissive and comprises a plurality of reflectors that are densely distributed therein and are capable of reflecting light. The organization layer is connected to and located under the reflection layer and is made up of a plurality of sub-layers. The sub-layers of the organization layer comprise a lining layer that is connected to the reflection layer and at least one yarn layer.

The effect of the present invention in use is that with the present invention located in a dark environment and irradiated with light, when the light reaches and get incident onto the reflection layer of the tube of the present invention, the light is allowed to transmit through the transparent and thus light-transmitting reflection layer to get incident on the large number of reflectors embedded in the reflection layer so that the light is reflected by the reflectors back to project outward through the reflection layer. As such, the reflection of light makes the tube prominently noticeable, and an effect of indication of the tube is achieved, allowing the tube to be readily identified and found for being subsequently used or otherwise used.

The foregoing objectives and summary provide only a brief introduction to the present invention. To fully appreciate these and other objects of the present invention as well as the invention itself, all of which will become apparent to those skilled in the art, the following detailed description of the invention and the claims should be read in conjunction with the accompanying drawings. Throughout the specification and drawings identical reference numerals refer to identical or similar parts.

Many other advantages and features of the present invention will become manifest to those versed in the art upon making reference to the detailed description and the accompanying sheets of drawings in which a preferred structural embodiment incorporating the principles of the present invention is shown by way of illustrative example.

### BRIEF DESCRIPTION OF THE DRAWINGS

FIG. 1 is a perspective view, partly removed, showing an example of the present invention.

FIG. 2 is a cross-sectional view showing the present invention.

FIG. 3 is a schematic view illustrating a condition of use of the present invention.

### DETAILED DESCRIPTION OF THE PREFERRED EMBODIMENTS

The following descriptions are exemplary embodiments only, and are not intended to limit the scope, applicability or configuration of the invention in any way. Rather, the following description provides a convenient illustration for implementing exemplary embodiments of the invention. Various changes to the described embodiments may be made in the function and arrangement of the elements described without departing from the scope of the invention as set forth in the appended claims.

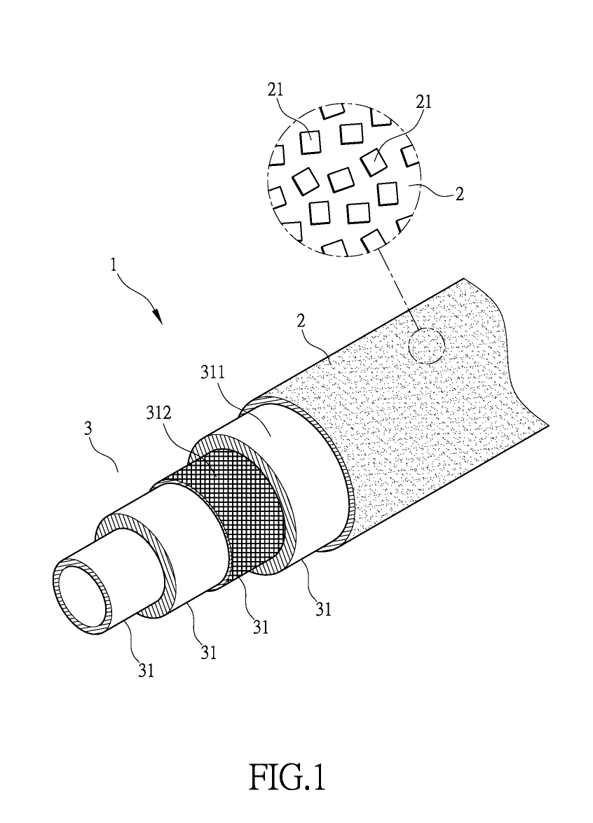

Firstly, referring to FIG. 1, the present invention provides a tube with indication function. The tube 1 of the present invention comprises, at least, a reflection layer 2 and an organization layer 3. The reflection layer 2 is located on the outermost layer of the tube 1. The reflection layer 2 is transparent and comprises reflectors 21, which are reflective to light, distributed densely in an interior thereof. The organization layer 3 is connected to and located under the reflection layer 2 and is made up of a plurality of sub-layers 31. The sub-layers 31 include a lining layer 311 that is connected to the reflection layer 2 and at least one yarn layer 312.

To manufacture, in the fabrication concerning the reflectors 21 of the reflection layer 2, a number of reflectors 21 are mixed and embedded in a plastic material that is used to make the reflection layer 2 so that with the formation of the reflection layer 2, the reflectors 21 are embedded in and distributed, in a dense arrangement, in the reflection layer 2, whereby the reflectors 21 are housed in and securely embedded and retained in the reflection layer 2. Further, the reflectors 21 could be of any desired forms, such as particulates and flasks, and could be colorless or any color. Upon irradiation of light thereon, the reflectors 21 reflects the light back, and different colors involved therein allow for reflection of light with different colors from the reflectors.

The lining layer 311 that is connected to the reflection layer 2 is preferably of a dark color, and more preferably a black color. By setting the lining layer 311 with a dark color or even black color, in reflecting light with the reflectors 21 embedded in the reflection layer 2, the light so reflected would be more prominent and more noticeable. This help enhances the prominent function of indication. Further, in the present invention, the yarn layer 312 is located between any two sub-layers 31 of the organization layer 3. With the arrangement of the yarn layer 312, the stiffness of the tube 1 could be improved to provide a better effect of use.

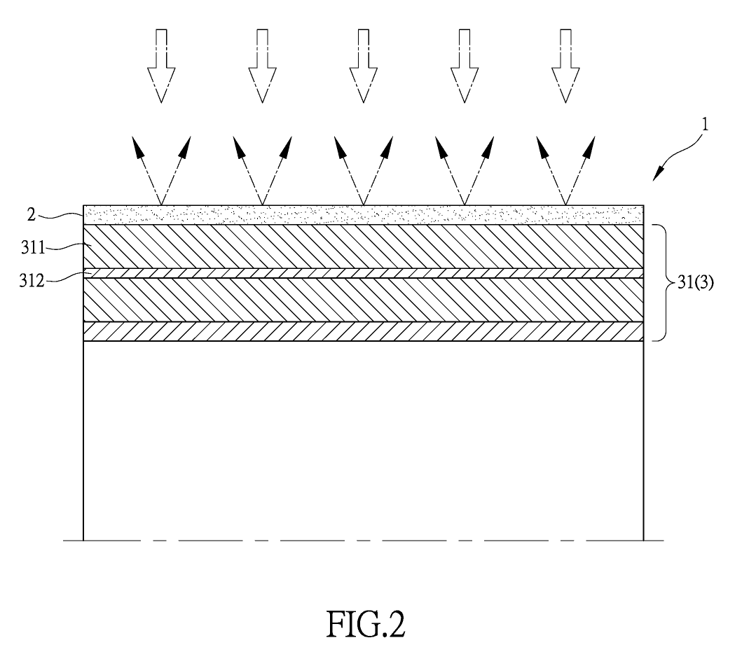

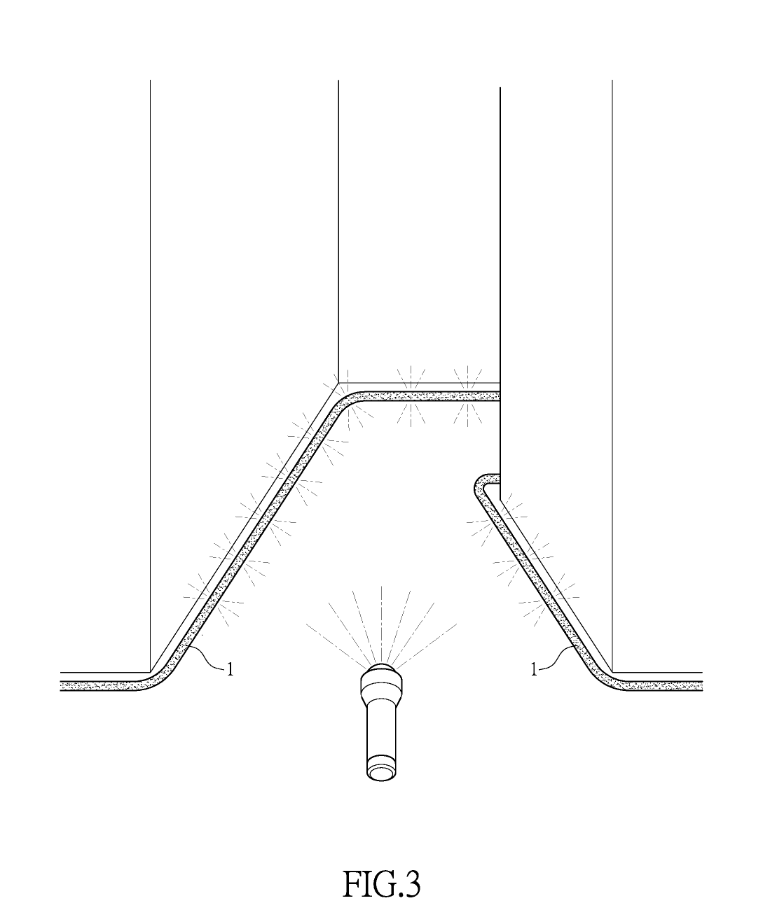

Referring further to FIGS. 2 and 3, the tube 1 of the present invention can be used in a known way of conveying gas and liquid or enclosing and housing electrical wires for conveyance of electrical power. When set up in a dark environment, the tube 1 of the present invention, upon irradiation with light, allows the light to reach the reflection layer 2 of the tube 1 such that the transparency of the reflection layer 2 allows for penetration of the light therethrough to get further into the interior thereof, wherein the reflectors 21 embedded in reflection layer 2 receives and reflects the light. The reflected light travels, once again, through the reflection layer 2 that is transparent to project outward. As such, the reflection of light makes the tube 1 noticeable, allowing the tube 1 to be found and identified immediately for use

It will be understood that each of the elements described above, or two or more together may also find a useful application in other types of methods differing from the type described above.

While certain novel features of this invention have been shown and described and are pointed out in the annexed claim, it is not intended to be limited to the details above, since it will be understood that various omissions, modifications, substitutions and changes in the forms and details of the device illustrated and in its operation can be made by those skilled in the art without departing in any way from the claims of the present invention.

I claim:

1. A tube with indication function, comprising:
a reflection layer, which is located on an outermost layer of the tube, the reflection layer comprising reflectors embedded and densely distributed therein; and
an organization layer, which is connected to and located under the reflection layer and comprises of a plurality of sub-layers.

2. The tube with indication function according to claim 1, wherein the reflection layer is transparent.

3. The tube with indication function according to claim 1, wherein the reflectors embedded in the reflection layer are in the form of particulate.

4. The tube with indication function according to claim 1, wherein the reflectors embedded in the reflection layer are in the form of flake.

5. The tube with indication function according to claim 1, wherein the reflectors embedded in the reflection layer are colorless or a predetermined color.

6. The tube with indication function according to claim 1, wherein the sub-layers of the organization layer include a lining layer connected to the reflection layer.

7. The tube with indication function according to claim 6, wherein the lining layer is of a dark color.

8. The tube with indication function according to claim 7, wherein the lining layer has a black color.

9. The tube with indication function according to claim 1, wherein the sub-layers of the organization layer include at least one yarn layer.

10. The tube with indication function according to claim 9, wherein the yarn layer is arranged between two of the sub-layers of the organization layer.
